(19) United States
(12) Patent Application Publication
(10) Pub. No.: US 2015/0225289 A1
(43) Pub. Date: Aug. 13, 2015

(54) Fiberglass Laminate

(71) Applicant: Gosakan Aravamudan, Bangalore (IN)

(72) Inventor: Gosakan Aravamudan, Bangalore (IN)

(21) Appl. No.: 14/615,427

(22) Filed: Feb. 6, 2015

(30) Foreign Application Priority Data
Feb. 7, 2014 (IN) 576/CHE/2014

(51) Int. Cl. C03C 25/34

(52) U.S. Cl. CPC C03C 25/34; C03C 2218/118; C03C 2217/72; C03C 2217/78

(57) ABSTRACT

A high color quality, fire resistant, pinstripe decorative fiberglass laminate is provided. The pinstripe decorative fiberglass laminate includes colored unidirectional glass fiber rovings in a fire resistant resin matrix. Pigmented unidirectional glass fiber rovings provide a pinstriped effect with substantial color richness and aesthetic quality. For light colored pinstripes, colored unidirectional glass fiber rovings are impregnated with a melamine resin and cured to form the fire resistant, pinstripe decorative fiberglass laminate. For dark colored pin stripes, colored unidirectional glass fiber rovings are impregnated with a phenolic resin and cured to form the fire resistant, pinstripe decorative fiberglass laminate.

### CROSS REFERENCE TO RELATED APPLICATIONS

This application claims priority to and the benefit of provisional patent application number 576/CHE/2014 titled “Fiberglass Laminate”, filed in the Indian Patent Office on Feb. 7, 2014, and non-provisional patent application number 576/CHE/2014 titled “Fiberglass Laminate”, filed in the Indian Patent Office on Feb. 5, 2015. The specifications of the above referenced patent applications are incorporated herein by reference in their entirety.

### BACKGROUND

The invention disclosed herein, in general, relates to composites. More particularly, the invention disclosed herein relates to a pinstripe decorative fiberglass laminate.

Currently available decorative laminates such as high pressure laminates and low pressure laminates do not provide sufficient color richness. The color quality is limited by the presence of print on a cellulosic paper. Moreover, the cellulosic content in a high pressure laminate makes it unsuitable for highly fire resistant applications such as surfacing applications in the aerospace industry.

Conventional methods use a decorative cellulosic paper on a fire resistant glass fiber paper for creating a decorative laminate. However, the aesthetics of these solutions are restricted by color quality constraints of the decorative cellulosic paper. Directly coloring a fiberglass woven mat or a non-woven glass chopped fiber surface mat of low weight, for example, of about 30 grams per square meter (gsm) does not provide color sharpness and image clarity. The color clarity and resolution of the print in these solutions are insufficient for high clarity pinstripe designs.

Hence, there is an unmet need for a pinstripe decorative laminate that provides straight line color sharpness, color quality, and high fire resistance.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The fiberglass laminate disclosed herein addresses the above mentioned need for color sharpness of a pinstriped effect and high fire retardancy. The pinstripe decorative fiberglass laminate disclosed herein comprises colored unidirectional zero twist glass fiber rovings. Pigmented unidirectional zero twist glass fiber rovings provide a pinstriped effect with substantial color richness and aesthetic quality. The colored straight lined zero twist glass fiber rovings provide substantial straight line color clarity. The untwisted transparent colored fibers create a substantial color effect.

For light colored pinstripes, colored zero twist unidirectional glass fiber rovings are impregnated with a melamine resin and cured to form the fire resistant, pinstripe decorative fiberglass laminate. For dark colored pin stripes, colored zero twist unidirectional glass fiber rovings are impregnated with a phenolic resin and cured to form the fire resistant, pinstripe decorative fiberglass laminate.

As typical direct rovings with twist do not provide sharp pinstripe patterns, zero twist rovings are required. Furthermore, color sharpness of colored zero twist unidirectional glass fiber rovings is substantial when compared to color sharpness obtained by directly coloring a fiberglass woven mat or a non-woven glass chopped fiber surface mat of low weight, for example, of about 30 grams per square meter (gsm).

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a fire resistant, pinstripe decorative fiberglass laminate comprising colored zero twist unidirectional glass fiber rovings.

FIG. 2 exemplarily illustrates an apparatus for manufacturing the fire resistant, pinstripe decorative fiberglass laminate.

### DETAILED DESCRIPTION OF THE INVENTION

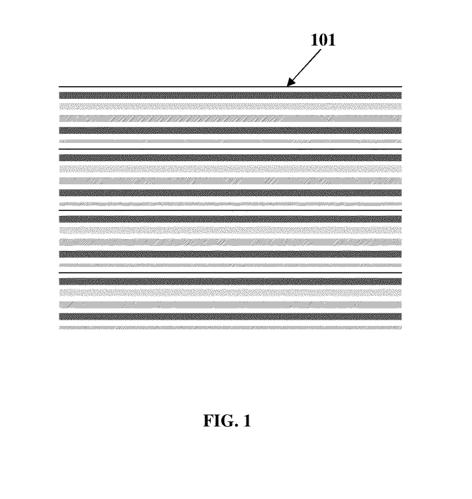

FIG. 1 exemplarily illustrates a fire resistant, pinstripe decorative fiberglass laminate 101 comprising colored zero twist unidirectional glass fiber rovings. As used herein, “zero twist unidirectional glass fiber rovings” refer to bundles of continuous single filament glass fibers in which there are no twists. Pigmented zero twist unidirectional glass fiber rovings provide a pinstriped effect with substantial color richness and aesthetic quality. As used herein, “pinstriped effect” refers to a design pattern of thin stripes.

For light colored pinstripes, colored unidirectional glass fiber rovings are impregnated with a melamine resin and cured to form the fire resistant, pinstripe decorative fiberglass laminate 101. For dark colored pin stripes, colored unidirectional glass fiber rovings are impregnated with a phenolic resin and cured to form the fire resistant, pinstripe decorative fiberglass laminate 101.

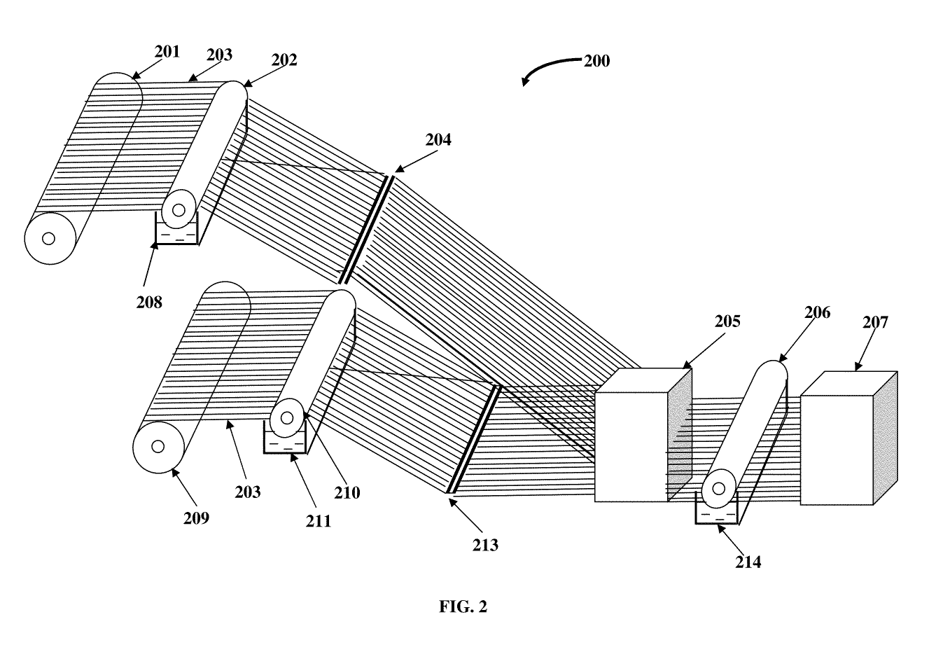

FIG. 2 exemplarily illustrates an apparatus 200 for manufacturing the fire resistant, pinstripe decorative fiberglass laminate 101 shown in FIG. 1. The apparatus 200 disclosed herein comprises beams 201 and 209, rollers 202 and 210 operably positioned within color trays 208 and 211 respectively, a roller 206 operably positioned within a resin tank 214, fiber guides 204 and 213, and heat chambers 205 and 207. The color trays 208 and 211 contain different color solutions. Glass fiber rovings 203 having a linear mass density in the range of, for example, about 100 tex and about 300 tex, originate from the beams 201 and 209 and are color coated by the rollers 202 and 210 positioned in the color trays 208 and 211 respectively. The color coated glass fibers are then aligned through a first set of fiber guides 204 and 213 and dried by passing through the first heat chamber 205. The dried color coated glass fibers are then dipped in the resin tank 214 containing a melamine resin or a phenolic resin, through the roller 206, placed adjacent to each other via a second set of fiber guides (not shown), and heat cured at 150° Celsius in the second heat chamber 207. The resulting pinstripe decorative fiberglass laminate 101 is fire resistant and has substantial color sharpness in its pinstripe design. FIG. 2 exemplarily illustrates two rollers 202 and 210 positioned in the color trays 208 and 211 respectively, containing two different color solutions. However, a multiplicity of rollers, that is, more than two rollers, each positioned in a color tray containing a different color solution can be used to create a rich pinstriped effect in the pinstripe decorative fiberglass laminate 101.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A fire resistant, pinstripe decorative fiberglass laminate comprising colored unidirectional glass fiber rovings that are impregnated with a fire resistant resin.

2. The fire resistant, pinstripe decorative fiberglass laminate of claim 1, wherein said fire resistant resin is one of a melamine resin and a phenolic resin.
